(19) United States
(12) Patent Application Publication
(10) Pub. No.: US 2018/0078875 A1
(43) Pub. Date: Mar. 22, 2018

(54) METHOD AND AN APPARATUS FOR CONTROLLING FLUID FLOWING THROUGH A CHROMATOGRAPHIC SYSTEM

(71) Applicant: Waters Technologies Corporation, Milford, MA (US)

(72) Inventors: Kurt D. Joudrey, Chelmsford, MA (US); Paul Keenan, Harrisville, RI (US); Richard W. Andrews, Rehoboth, MA (US); Peyton C. Beals, Wrentham, MA (US); Joshua A. Shreve, Franklin, MA (US)

(21) Appl. No.: 15/790,946

(22) Filed: Oct. 23, 2017

Related U.S. Application Data
(62) Division of application No. 14/539,336, filed on Nov. 12, 2014.
(60) Provisional application No. 61/903,547, filed on Nov. 13, 2013.

(51) Int. Cl. B01D 15/10; G01N 30/32; B01D 15/40; B01D 15/16; G01N 30/30

(52) U.S. Cl. CPC B01D 15/10; G01N 30/32; G01N 2030/324; B01D 15/163; G01N 2030/3007; B01D 15/40

(57) ABSTRACT

A method for controlling fluid flowing through a chromatographic system includes determining a fluidic parameter related to density at a first fluidic location in the chromatographic system; and in response to the determined fluidic parameter, modifying a volumetric flow rate or a pressure at a second fluidic location in the chromatographic system to produce a selected mass flow rate of the fluid.

### CROSS-REFERENCE TO RELATED APPLICATION

This application claims priority to and benefit of U.S. Provisional Application No. 61/903,547 filed Nov. 13, 2013, the contents and teachings of which are incorporated herein by reference in their entirety.

### TECHNICAL FIELD

This disclosure relates generally to controlling fluid flowing through a chromatographic system, and, more particularly, to controlling mass flow rates of a mobile phase in supercritical fluid chromatography (SFC).

### BACKGROUND

The volumetric or mass flow rate of a mobile phase through a chromatographic column affects mass transfer kinetics in the column and thus affects the separation power. Accordingly, the flow rate, if stable, can support stable chromatography efficiency. In liquid chromatography (LC), a mobile phase is a solvent, or a mixture of solvents, in a liquid state with almost indiscernible compressibility such that the volumetric flow rate of a LC mobile phase is quite stable and reproducible, regardless of fluctuation in pressure and temperature, and can therefore be well controlled to influence chromatographic performance. In SFC, a mobile phase is typically a supercritical or near-supercritical fluid, in a state near or above the critical point of its phase transition profile, which has two characteristics: 1) there is no distinct phase boundary between liquid or gas and the supercritical state; and 2) any small changes in pressure and/or temperature can cause substantial changes in density. As a result, the volumetric flow rate of a SFC mobile phase can vary significantly along its flow path and is not a stable property for measuring and controlling chromatography efficiency.

The mass flow rate of a SFC mobile phase, on the other hand, is stable and constant through a chromatographic column. Hence, the column efficiency can be measured and influenced by controlling the mass flow rate. A common approach to controlling the mass flow rate of a SFC mobile phase involves a mass flow sensor, which is typically placed near the column to measure the mass flow passing through. Unfortunately, a mass flow sensor can be expensive, especially those for low flow rates.

### SUMMARY

Some embodiments arise, in part, from the realization that the mass flow rate of a chromatographic mobile phase can be controlled without a mass flow sensor. Such embodiments are useful at both low flow rates, e.g., analytical flow rates, and at higher flow rates, e.g., preparative flow rates. In exemplary embodiments, analytical flow rates can be less than about 10 mL/min and preparative flow rates can be greater than about 10 mL/min. For example, a selected mass flow rate can be obtained by determining a density, based on knowledge of pressure and temperature, and responsively modifying a volumetric flow rate to yield the selected mass flow rate.

One embodiment provides a method for controlling fluid flowing through a chromatographic system, which includes determining a fluidic parameter related to density at a first fluidic location in the chromatographic system; and, in response to the determined fluidic parameter, modifying a volumetric flow rate or a pressure at a second fluidic location in the chromatographic system to produce a selected mass flow rate of the fluid.

Another embodiment features a chromatographic system that includes a pump unit configured to deliver a volumetric flow rate; a fluidic parameter sensor disposed to measure a fluidic parameter at a location in the chromatography system; and a pump control unit configured to adjust the volumetric flow rate of the pump unit, in response to the measured fluidic parameter, to deliver a selected mass flow rate of a fluid in the chromatographic system.

Implementations may include one or more of the following features.

In some implementations, the fluid is in or near to a supercritical state. In particular, some preferred embodiments entail SFC systems. Cost savings can be realized, for example, in a relatively low flow rate SFC system embodiment, in which precise mass flow rate control does not require an expensive mass flow sensor.

Some low flow rate embodiments entail an analytical flow rate, for example, less than about 10 mL/min. Other higher flow rate embodiments can entail a preparative flow rate, for example greater than about 10 mL/min.

In some implementations, a determined fluidic parameter is pressure, a substantially constant temperature of the fluid is maintained, and the values of the temperature and the pressure provide a measure of the density. The pressure may be determined and the temperature maintained at locations proximate to each other.

In some cases, first and second fluidic locations are substantially co-located. For example, the first fluidic location can be associated with a manifold or a head of a pump unit, and the second fluidic location can be associated with an outlet of the pump unit.

In some embodiments, a system includes an injector, located downstream of a pump unit, to inject a sample to the fluid. The system can include a pressure metering device as its fluidic parameter sensor, disposed upstream of the injector, to measure the pressure of the fluid before a sample is injected. In some implementations, the pressure metering device is capable of both modifying and measuring the pressure of the fluid. The pump unit can include a first pump and a second pump, connected in series.

### BRIEF DESCRIPTION OF THE DRAWINGS

In the drawings, same or like reference characters and numbers generally refer to same or like elements throughout different views. Also, the drawings are not necessarily to scale.

FIG. 1 is a schematic overview of a chromatography system 100, in accordance with one embodiment of the invention.

FIG. 2 is a flow diagram of a method for controlling the mass flow rate of a SFC mobile phase, in accordance with another embodiment of the invention.

### DETAILED DESCRIPTION

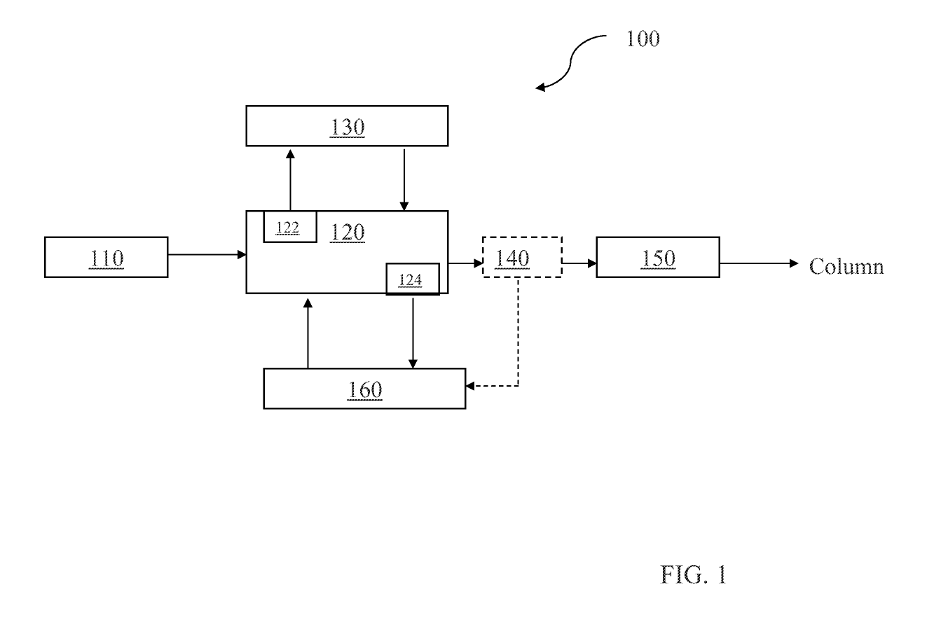

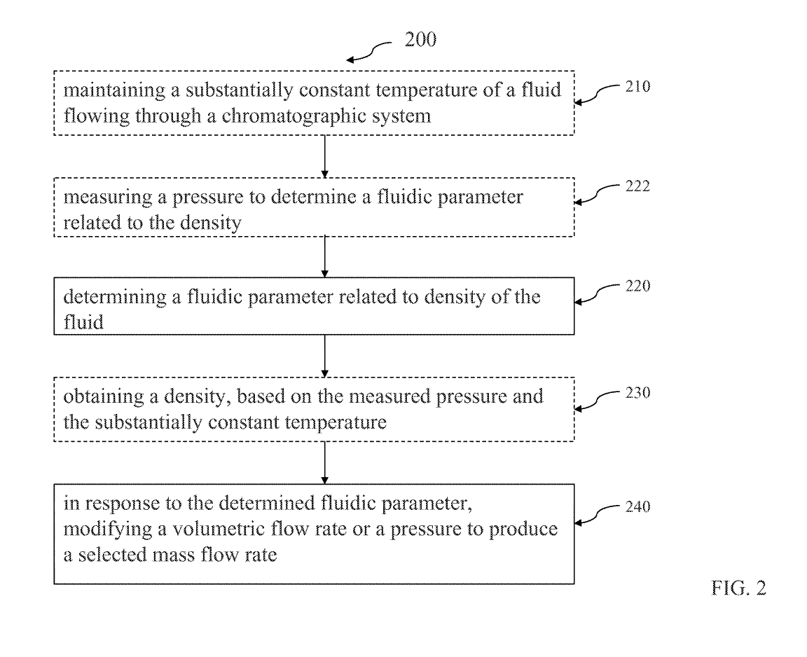

Some illustrative implementations will now be described with respect to FIGS. 1-2. In view of this description, claims and figures, modifications and alterations to these implementations, and alternative embodiments, will be apparent to one of ordinary skill.

The mass flow rate of a mobile phase at a fluidic location is proportional to the volumetric flow rate and the density of the mobile phase at the same location. Hence, if the density is known, then a selected mass flow rate can be achieved by modifying a volumetric flow rate. Density can be expressed as a function of temperature and pressure and estimated or determined if temperature and pressure are both known. For example, if the temperature is held constant at a fluidic location, then the density at that location can be determined from measurement of the pressure at the same location. Once the density is determined, the volumetric flow rate of the fluid can be modified to produce a selected mass flow rate.

FIG. 1 is a diagram of a chromatography system 100 that has features for controlling the mass flow rate of a carbon-dioxide based fluid, according to one non-exclusive embodiment of the invention. The system 100 includes a carbon dioxide source 110, a pump unit 120, a temperature sensor 122, a fluidic parameter sensor 124, a temperature control unit 130, an injector 150, and a pump control unit 160. The system 100 also optionally includes a pressure metering device 140, located between the pump unit 120 and the injector 150, presented by a dashed line box.

The carbon dioxide source 110 contains liquid carbon dioxide and supplies the carbon dioxide to the pump unit 120. The carbon dioxide, released from the source 110, is in or near a supercritical state, which, in some cases, can have a temperature lower than ambient temperature, e.g., 13° C., and a high pressure, e.g., above 1000 psi.

The pump unit 120 receives the carbon dioxide supplied from the carbon dioxide source 110 and delivers the carbon dioxide having avolumetric flow rate. For example, the volumetric flow rate can be an analytical flow rate, e.g., less than about 10 mL/min. In other exemplary embodiments, the volumetric flow rate can be a preparative flow rate, e.g., greater than about 10 mL/min. In some implementations, the pump unit 120 includes a primary pump and an accumulator (not shown), connected in series, as will be understood by one having ordinary skill in chromatography.

The temperature sensor 122 measures temperatures of the carbon dioxide and sends temperature signals to the temperature control unit 130. The temperature sensor 122 is preferably disposed at or near the fluidic parameter sensor 124 so that the temperature and fluidic parameter, e.g., pressure, measured from a same or close location can be used to derive a selected mass flow. In the implementation shown in FIG. 1, both the temperature sensor 122 and fluidic parameter sensor 124 are placed within the pump unit 120 to measure therefrom the temperature and pressure. In some implementations, more than one temperature sensor can be used to make multiple temperature measurements along the fluidic path and an average of the multiple measurements can be used in determining a density.

The temperature control unit 130, in cooperation with the temperature sensor 122, controls the temperature of the carbon dioxide. The temperature control unit 130 can be a Peltier cooling/heating device. In some implementations, the temperature is held near to an ambient temperature and maintained substantially constant throughout a chromatographic run, while the pressure can vary and be frequently measured. In other implementations, the temperature may vary as well during a run, and both pressure and temperature need to be measured regularly, at locations proximate to each other. In all of these implementations; a density is determined, based on knowledge of pressure and temperature; and a volumetric flow rate is responsively modified, based on the determined density, to yield a selected mass flow rate.

The fluidic parameter sensor 124 measures a fluidic parameter, e.g., a pressure, as in the implementation of FIG. 1. The measured pressure is used by the pump control unit 160 to determine the density of the carbon dioxide. The determined density is then used to calculate a volumetric flow rate required to produce a selected mass flow rate. Preferably, the fluidic parameter sensor 124 is disposed at a fluidic location associated with a manifold or a head of the pump unit 120, as the pump unit 120 is where the volumetric flow rate can be modified, through adjustment of velocity of the pump plunger (not shown), to generate a desired mass flow rate. The fluidic parameter sensor 124 sends pressure signals to the pump control unit 160.

The pump control unit 160, in signal communication with the fluidic parameter sensor 124, receives the pressure signals and determines the density of the carbon dioxide, in response to the pressure signals. The pump control unit 160 modifies the volumetric flow rate of the carbon dioxide, in response to the measured fluidic parameter and based on the determined density, to produce a selected mass flow rate. The pump control unit 160 includes, e.g., firmware capable of receiving the signals from the fluidic parameter sensor 124 and operating the pump unit 120, based on the received signals. The pump control unit 160 can include any commonly used computing system, which includes, but is not limited to, embedded processors, personal computers, server computers, hand-held or laptop devices, multiprocessor systems, microprocessor-based systems, programmable electronics, minicomputers, mainframe computers and the like known in the art.

The injector 150 injects a sample into the carbon-dioxide based mobile phase, which carries the sample to a chromatography column. The column can be a LC, such as a high-performance chromatography (HPLC), column, or any column packed with a stationary phase that is compatible with a carbon-dioxide based mobile phase.

In some implementations, where chromatography runs in an isocratic mode, e.g., the mobile phase is composed of only carbon dioxide, if the temperature is maintained substantially constant, then the pressure can be assumed unchanged at the point of measurement. In such implementations, the pressure can be measured, e.g., by the fluidic parameter sensor 124, only once during an entire run, and the density, derived from the temperature and pressure, can be assumed unchanged as well at the point of measurement of the pressure. The volumetric flow rate is then modified, based on the assumed unchanged density, at the point of measurement, to achieve a desired mass flow rate.

In other implementations, where chromatography runs in a gradient mode, e.g., the mobile phase is composed of more than one solvent, the pressure can vary at the point of measurement and decrease along the fluidic path. In such implementations, if the temperature is held substantially constant, the pressure can be measured continuously during an entire run, e.g., by the fluidic parameter sensor 124, and the density can be derived, based on a current pressure and the constant temperature. Consequently, the volumetric flow rate of the mobile phase is modified continuously, in response to continuous measurement of pressure, thereby to achieve a desired mass flow rate.

Optionally, the pressure metering device 140 can be added to the system 100 to control the pressure of the fluid at the pump unit 120, for example, to elevate the pressure at the pump unit 120 to yield a high mass flow rate, when the pressure drop along the fluidic path is minute. In some implementations, the pressure, instead of the volumetric flow rate, is modified, through the pressure metering device 140, to achieve a desired mass flow rate. Alternatively, both the volumetric flow rate and pressure can be modified to produce a desired mass flow rate.

The density of a mobile phase can be expressed as a function of temperature and pressure, if other properties of the mobile phase, e.g., viscosity, are known. In some implementations, the density is determined, based on a measured pressure and constant temperature, and a predetermined relationship between them. The relationship can be expressed by, e.g., a curve, a database table or a mathematical equation. Accordingly, the density can be determined by fitting the curve, referencing the table, or calculating from the equation.

Once the density (D) is determined, a volumetric flow rate (VFR) required to achieve a desired mass flow rate (MFR) can be calculated using the relationship: MFR=VFR*D, so a modified volumetric flow rate is selected to achieve a selected mass flow rate. The pump control unit 160 then modifies the volumetric flow rate, based on a calculation, to produce the selected mass flow rate.

FIG. 2 is a flow diagram of a method 200 for controlling fluid flowing through a chromatographic system, and, more particularly, for controlling mass flow rates of a SFC mobile phase, e.g., carbon dioxide in or near to a supercritical state. The method 200 includes the steps of: determining (220) a fluidic parameter related to density at a first fluidic location in the chromatographic system; and modifying (240), in response to the determined fluidic parameter, a volumetric flow rate or a pressure at a second fluidic location in the chromatographic system to produce a selected mass flow rate of the fluid.

The method can be implemented, for example, with the chromatography system 100, as illustrated in FIG. 1.

In some implementations, the volumetric flow rate is an analytical flow rate, e.g., less than about 10 mL/min, and the fluidic parameter is pressure. In other implementations, the volumetric flow rate can be a preparative flow rate, e.g., greater than about 10 mL/min, in the range of about 10 mL/min to about 300 mL/min, in the range of about 10 mL/min to about 80 mL/min, about 80 mL/min or higher, in the range of about 80 mL/min to about 150 mL/min, in the range of about 80 mL/min to about 300 mL/min, about 150 mL/min or higher, in the range of about 150 mL/min to about 300 mL/min, or about 300 mL/min or higher. The first and second fluidic locations are optionally substantially co-located, e.g., the first fluidic location can be associated with a manifold or a head of a pump unit, and the second fluidic location can be associated with an outlet of the pump unit.

The method 200 optionally includes maintaining (210) a substantially constant temperature of the fluid. In some implementations, maintaining (210) a substantially constant temperature involves a Peltier device, and the temperature can be maintained at a predetermined temperature, e.g., lower than an ambient temperature. The method 200 further optionally includes obtaining (230) a density, based on a measured pressure and the substantially constant temperature. Alternatively, if the temperature varies along the fluidic path, then it can be measured regularly as well and a measured temperature, together with a measured pressure, is used in obtaining (230) a density.

The step of determining (220) optionally is preceded by measuring (222) a pressure. The pressure is preferably measured at a pump unit of a chromatography system, for example, at a head of the pump unit 120 of the system 100 as in FIG. 1, because the pump is where a volumetric flow rate can be modified to deliver a selected mass flow rate. In the implementation of FIG. 1, the pressure is measured by the fluidic parameter sensor 124, disposed within the pump unit 120.

In one example of measuring (222), the pressure is measured only once during an entire run, if the chromatographic operation runs in an isocratic mode, e.g., the mobile phase is composed of only carbon dioxide, and if the temperature is held constant. In this example, the pressure is assumed to be the same as the measured from a particular location, e.g., at a pump head, then a density, derived from the measured pressure and constant temperature, can be assumed to be unchanged as well along the fluidic path. A volumetric flow rate can subsequently be modified, based on the assumed unchanged density, to produce a desired mass flow.

In another example of measuring (222), the pressure can be measured continuously during a run, because the pressure along the fluidic path can vary, if the chromatographic operation runs in a gradient mode, e.g., the mobile phase is composed of more than one solvent. In this example, a current pressure is used in obtaining (230) the density.

Alternatively, the pressure, instead of the volumetric flow rate, can be modified to produce a selected mass flow rate, in which case, the pressure metering device 140, as shown in FIG. 1, can also control the pressure in addition to measuring the pressure. In some implementations, both the volumetric flow rate and pressure can be modified to produce a desired mass flow rate.

In one example, if a temperature of the mobile phase is maintained at 13° C. and a measured pressure is 2500 psi, then the density (D) can be determined as 0.9529 g/ml, based on a predetermined relationship of density to pressure and temperature, recorded in a look-up table or calculated mathematically. As presented above, a volumetric flow rate (VFR) required to achieve a desired mass flow rate (MFR) can be calculated using the relationship: MFR=VFR*D. If a desired mass flow rate is 2.2 g/min, then the volumetric flow rate (VFR) required achieving the selected mass flow rate can be calculated, as follows:

$$V F R = 2.2 \frac{g}{min} * \frac{1}{0.9529} \frac{mL}{g} = 2.309 \frac{mL}{min}$$

Although a number of implementations have been described above, other modifications, variations and implementations will be apparent in light of the foregoing. For example, though, as described above, the fluid is a SFC mobile phase, e.g., carbon dioxide in or near to a supercritical state, the fluid can be a LC or HPLC mobile phase. For example, though, as described above, pumps included in a pump unit are optionally connected to each other in series, they can also be connected in parallel, wherein more than one temperature control unit may be used to control the temperature of the parallel pumps. Moreover, though, the method, as described above, is applied to a SFC mobile phase having an analytical volumetric flow rate, e.g., less than 10 mL/min, it works for high flow rates as well, e.g., greater than about 10 mL/min, in the range of about 10 mL/min to about 300 mL/min, in the range of about 10 mL/min to about 80 mL/min, about 80 mL/min or higher, in the range of about 80 mL/min to about 150 mL/min, in the range of about 80 mL/min to about 300 mL/min, about 150 mL/min or higher, in the range of about 150 mL/min to about 300 mL/min, or about 300 mL/min or higher.

Accordingly, the invention is to be defined not by the preceding illustrative description but instead by the scope of the following claims.

1.-22. (canceled)

23. A method for controlling fluid flowing through a chromatographic system, comprising:
delivering a flow of fluid from a pump at a volumetric flow rate;
measuring a fluidic parameter related to density at a first fluidic location in the chromatographic system;
determining a mass flow rate at the first fluidic location from the volumetric flow rate and the measured fluidic parameter related to density;
varying a composition of the fluid over time;
modifying the volumetric flow rate delivered by the pump to produce a selected mass flow rate based on the measured fluidic parameter related to density; and
passing the flow of fluid through a chromatographic column packed with a stationary phase.

24. The method of claim 23, wherein the fluid comprises carbon dioxide and is in or near to a supercritical state.

25. The method of claim 23, wherein the volumetric flow rate is an analytical flow rate less than about 10 mL/min.

26. The method of claim 23, wherein the volumetric flow rate is a preparative flow rate greater than about 10 mL/min.

27. The method of claim 23, wherein the fluidic parameter related to density is pressure and the method further comprises maintaining a constant temperature of the fluid proximate to the first fluidic location.

28. The method of claim 27, wherein the temperature is held constant with a Peltier device.

29. The method of claim 27, further comprising measuring a temperature of the fluid proximate to the first fluidic location.

30. The method of claim 23, further comprising injecting a sample into the flow of fluid at a position downstream from the pump.

31. The method of claim 23, further comprising modifying a pressure of the fluid at a position downstream from the pump.

32. A method for controlling fluid flowing through a chromatographic system, comprising:
delivering a flow of fluid from a pump at a volumetric flow rate;
maintaining a constant temperature of the fluid proximate to a first location in the chromatographic system;
measuring a pressure of the fluid at the first location in the chromatographic system;
determining a mass flow rate at the first location from the volumetric flow rate and the measured pressure;
varying a composition of the fluid over time;
modifying the volumetric flow rate delivered by the pump to produce a selected mass flow rate based on the measured pressure; and
passing the flow of fluid through a chromatographic column packed with a stationary phase.

33. The method of claim 32, further comprising injecting a sample into the flow of fluid at a position downstream from the pump.

34. The method of claim 32, further comprising modifying a pressure of the fluid at a position downstream from the pump.

35. A chromatography system, comprising:
a pump configured to deliver fluid at a volumetric flow rate;
a sensor configured to measure a parameter of fluid flowing from the pump related to density;
a chromatographic column packed with a stationary phase, the column being coupled to the pump and configured to receive the fluid flowing from the pump; and
a pump control unit in signal communication with the pump and the sensor;
wherein the fluid includes a plurality of solvents with a composition that varies over time;
wherein the pump control unit is configured to
i) determine a mass flow rate of the fluid from the volumetric flow rate of the pump and the parameter measured by the sensor;
ii) modify the volumetric flow rate of the pump to produce a selected mass flow rate based on the parameter measured by the sensor.

36. The system of claim 35, wherein the fluid comprises carbon dioxide and is in or near to a supercritical state.

37. The system of claim 35, wherein the pump includes a primary pump and an accumulator connected in series.

38. The system of claim 35, further comprising a temperature sensor configured to measure a temperature of the fluid proximate to the sensor.

39. The system of claim 38, further comprising a temperature control unit in signal communication with the temperature sensor and configured to adjust a temperature of the fluid in response to the measured temperature to maintain a constant temperature proximate the sensor.

40. The system of claim 39, further comprising a Peltier device in signal communication with the temperature control unit and configured to adjust the temperature of the fluid.

41. The system of claim 35, further comprising an injector positioned downstream from the pump and configured to inject a sample into the fluid.

42. The system of claim 35, further comprising a pressure metering device positioned downstream from the pump and configured to modify a pressure of the fluid.

43. The system of claim 35, wherein the parameter of the fluid is pressure.
